(19) United States
(12) Patent Application Publication
(10) Pub. No.: US 2024/0157836 A1
(43) Pub. Date: May 16, 2024

(54) SYSTEMS AND METHODS FOR ENERGY DISTRIBUTION ENTITIES AND NETWORKS FOR ELECTRIC VEHICLE ENERGY DELIVERY

(71) Applicant: BluWave Inc., Ottawa (CA)

(72) Inventors: Christopher GALBRAITH, Ottawa (CA); Keegan Michael John GREEN, Ottawa (CA); Nasrin SADEGHIANPOURHAMAMI, Ottawa (CA); Alexander LINCHIEH, Ottawa (CA); Devashish PAUL, Ottawa (CA); Mostafa FARROKHABADI, Ottawa (CA)

(21) Appl. No.: 17/988,416

(22) Filed: Nov. 16, 2022

(51) Int. Cl. B60L 53/64; B60L 53/66; G06Q 30/02

(52) U.S. Cl. CPC B60L 53/64; B60L 53/665; G06Q 30/0202

(57) ABSTRACT

Improvements in energy distribution for electric vehicle (EV) energy delivery technologies are provided. An EV charging station management system optimizes the use of various sources of power for charging EVs. The optimizing may be based on current and/or forecasted EV charging demand, and the amount of greenhouse gas emissions produced by various sources to generate the power used for EV charging. In another embodiment, the optimizing may be based on current and/or forecasted EV charging demand, and current or forecasted cost of acquiring power from a power grid, which varies over time. The system may be configured to maximize earnings from EV charging at one or more charging stations.

### FIELD

The present disclosure relates generally to improvements in energy distribution for electric vehicle (EV) energy delivery technologies.

### BACKGROUND

With the proliferation of EVs, optimal energy management of EVs is generally desirable to increase system or environmental benefits.

Furthermore, it is becoming more desirable, at least in some instances, to use renewable energy sources in the place of more traditional energy sources such as fossil fuels. Some driving forces behind the use of renewable energy include environmental responsibility.

There are some existing techniques that attempt to improve the efficiency of charging EVs, for example by attempting to schedule EVs charging when energy costs are relatively low. However, further improvements in EV charging-related technologies are desirable.

The above information is presented as background information only to assist with an understanding of the present disclosure. No assertion or admission is made as to whether any of the above, or anything else in the present disclosure, unless explicitly stated, might be applicable as prior art with regard to the present disclosure.

### SUMMARY

According to an aspect, the present disclosure is directed to a system comprising a computer-readable storage medium having executable instructions, and one or more hardware processors configured to execute the instructions to receive electric vehicle (EV) charging demand information, receive energy cost information for an EV charging station, the energy cost information including current energy cost information and forecasted energy cost information, wherein actual energy costs vary over time, execute an optimizer for maximizing predicted earnings on EV charging at the EV charging station based on the EV charging demand information and the energy cost information, wherein the maximizing comprises determining a dynamic optimized EV charging price, and charge one or more EVs using the EV charging station at the dynamic optimized price.

In an embodiment, the maximizing further comprises determining a rate at which to charge a local energy storage system (ESS) using energy from a power grid, a rate at which to discharge energy from the ESS for charging the one or more EVs, or to neither charge nor discharge the ESS.

In an embodiment, the one or more hardware processors are configured to execute the instructions to generate forecasted on-site power generation information for one or more power generation sources of the EV charging station, wherein the maximizing predicted earnings is also based on the forecasted on-site power generation information.

In an embodiment, the one or more hardware processors are configured to execute the instructions to transmit a signal to electronic devices of EV users indicative of the dynamic optimized EV charging price.

In an embodiment, the EV charging demand information includes current EV charging demand information and forecasted EV charging demand information.

the optimizer maximizes predicted earnings over a time horizon window, wherein the EV charging demand information comprises forecasted EV charging demand information.

In an embodiment, the optimizer is configured for maximizing predicted earnings in the time horizon window by optimizing at least one of EV charging price at points in time in the time horizon window, and a schedule in the time horizon window for charging a local energy storage system (ESS) using energy from a power grid, and for discharging energy from the ESS for charging the one or more EVs.

In an embodiment, the forecasted EV charging demand information is based at least in part on one or more of forecasted weather information and forecasted traffic information.

In an embodiment, the one or more hardware processors are configured to execute the instructions to receive EV charging demand information for each of a plurality of EV charging stations, receive energy cost information for each of the plurality of EV charging stations, execute the optimizer for maximizing predicted combined earnings on EV charging at the plurality of EV charging stations based on the EV charging demand information and the energy cost information, wherein the maximizing comprises determining a dynamic optimized EV charging price at each of the plurality of charging stations, and charge one or more EVs using at least one of the EV charging stations at the respective dynamic optimized price for that EV charging station.

According to an aspect, the present disclosure is directed to a method comprising at one or more electronic devices each having one or more hardware processors and computer-readable memory receiving electric vehicle (EV) charging demand information, receiving energy cost information for an EV charging station, the energy cost information including current energy cost information and forecasted energy cost information, wherein actual energy costs vary over time, executing an optimizer for maximizing predicted earnings on EV charging at the EV charging station based on the EV charging demand information and the energy cost information, wherein the maximizing comprises determining a dynamic optimized EV charging price, and charging one or more EVs using the EV charging station at the dynamic optimized price.

In an embodiment, the maximizing further comprises determining a rate at which to charge a local energy storage system (ESS) using energy from a power grid, a rate at which to discharge energy from the ESS for charging the one or more EVs, or to neither charge nor discharge the ESS.

In an embodiment, the method further comprises generating forecasted on-site power generation information for one or more power generation sources of the EV charging station, wherein the maximizing predicted earnings is also based on the forecasted on-site power generation information.

In an embodiment, the method further comprises transmitting a signal to electronic devices of EV users indicative of the dynamic optimized EV charging price.

In an embodiment, the EV charging demand information includes current EV charging demand information and forecasted EV charging demand information.

In an embodiment, the optimizer maximizes predicted earnings over a time horizon window, wherein the EV charging demand information comprises forecasted EV charging demand information.

In an embodiment, the optimizer is configured for maximizing predicted earnings in the time horizon window by optimizing at least one of EV charging price at points in time in the time horizon window, and a schedule in the time horizon window for charging a local energy storage system (ESS) using energy from a power grid, and for discharging energy from the ESS for charging the one or more EVs.

In an embodiment, the forecasted EV charging demand information is based at least in part on one or more of forecasted weather information and forecasted traffic information.

In an embodiment, the method comprises receiving EV charging demand information for each of a plurality of EV charging stations, receiving energy cost information for each of the plurality of EV charging stations, executing the optimizer for maximizing predicted combined earnings on EV charging at the plurality of EV charging stations based on the EV charging demand information and the energy cost information, wherein the maximizing comprises determining a dynamic optimized EV charging price at each of the plurality of charging stations, and charging one or more EVs using at least one of the EV charging stations at the respective dynamic optimized price for that EV charging station.

According to an aspect, the present disclosure is directed to a non-transitory computer-readable medium having computer-readable instructions stored thereon, the computer-readable instructions executable by at least one processor to cause the performance of operations comprising receiving electric vehicle (EV) charging demand information, receiving energy cost information for an EV charging station, the energy cost information including current energy cost information and forecasted energy cost information, wherein actual energy costs vary over time, executing an optimizer for maximizing predicted earnings on EV charging at the EV charging station based on the EV charging demand information and the energy cost information, wherein the maximizing comprises determining a dynamic optimized EV charging price, and charging one or more EVs using the EV charging station at the dynamic optimized price.

In an embodiment, the maximizing further comprises determining a rate at which to charge a local energy storage system (ESS) using energy from a power grid, a rate at which to discharge energy from the ESS for charging the one or more EVs, or to neither charge nor discharge the ESS.

The foregoing summary provides some example aspects and features according to the present disclosure. It is not intended to be limiting in any way. For example, the summary is not necessarily meant to identify important or crucial features of the disclosure. Rather, it is merely meant to introduce some concepts according to the disclosure. Other aspects and features of the present disclosure are apparent to those ordinarily skilled in the art upon review of the following description of specific example embodiments in conjunction with the accompanying figures.

### BRIEF DESCRIPTION OF THE DRAWINGS

Example embodiments of the present disclosure will now be described with reference to the attached Figures.

FIG. 1 is a block diagram of an example EV charging system.

FIG. 2 is a block diagram of an example EV charging system comprising an EV charging management system.

FIG. 3 is a block diagram of an example EV charging system comprising an EV charging management system in communication with multiple EV charging stations.

FIG. 4 is an information flow and block diagram in an example EV charging management system.

FIG. 5 is a block diagram of an example EV charging system comprising an EV charging management system.

FIG. 6 is a diagram showing an example receding horizon optimization arrangement.

FIG. 7 is a process flow diagram of an example method.

FIG. 8 is a block diagram of an example computerized device or system.

The relative sizes and relative positions of elements in the drawings are not necessarily drawn to scale. For example, the shapes of various elements and angles are not necessarily drawn to scale, and some of these elements may be arbitrarily enlarged and/or positioned to improve the readability of the drawings. Further, the particular shapes of the elements as drawn are not necessarily intended to convey any information regarding the actual shape of the particular elements, and have been solely selected for ease of recognition in the drawings.

### DETAILED DESCRIPTION

This disclosure generally relates to improvements in energy distribution for electric vehicle (EV) energy delivery technologies.

In an aspect, the present disclosure relates to improvements in energy distribution systems and methods for providing electrical energy for use in EV charging at one or more EV charging stations. A system may determine efficient times or schedules for charging EVs, determine the source(s) of energy to be used for current EV charging (for example energy from a power grid, on-site renewable power, on-site non-renewable power, energy stored in an ESS, etc.), or times or schedules for charging and discharging energy from one or more ESSs. Such systems may provide improvements to energy systems and technologies, for example by enabling the increased use of renewable power sources for EV charging, or to reduce the chances that on-peak power from a power grid is used, thereby possibly reducing an overall amount of greenhouse gas emissions that are produced to generate the energy used for EV charging.

In an aspect, an EV charging station management system may include a computer implemented optimizer configured for maximizing predicted earnings on EV charging at one or more EV charging stations. A variable EV charging price to clients may be a quantity to be optimized. The energy cost to the charging station may be a quantity to be minimized by the optimization. In an embodiment, a variable EV charging pricing scheme maybe used to maximize the EV charging earnings. In an embodiment, the optimization may be used for real-time control of one or more EV charging stations.

In an aspect, an EV charging station management system may include an optimizer configured for minimizing operating costs of the EV charging station. Operating cost may include the cost of the energy used by the EV charging station to charge EVs. In an embodiment, minimizing operating costs of an EV charging station may consist or comprise minimizing the cost of energy used by the EV charging station to charge EVs. An EV charging station may be able to acquire or use energy from several different sources, for example a power grid, from on-site or remote renewable energy generation, or from on-site or remote energy storage system(s) (ESS). The cost of energy and/or amount of power generated from one or more of these various sources may vary over time. Thus, a computer implemented forecaster may be used to forecast the costs of energy over time and/or the amount of power generated over time. This information may be used by the optimizer to control the use of various energy sources in order to minimize energy costs to the EV charging station. For example, at a given time, it may be less costly to charge an EV at the charging station using energy stored in an on-site ESS rather than using energy bought from the power grid. The energy used from the ESS may be replenished later on, for example by charging the ESS from the power grid at a later time when the cost of energy from the power grid is at a lower price point. In another example, the energy used from the ESS may be replenished later, for example by charging the ESS from a renewable power source at a time when there is an abundance of low cost renewable energy available.

In an aspect, the present disclosure relates to an EV charging management system for an EV charging station or multiple EV charging stations that may offer EV charging as a paid service. A paid service may be provided to the general public, to entities operating EVs in an institutional setting such as an airport, military base, etc., to EV fleet operators, or to any other suitable entities. The EV charging station may have one or more EV chargers, and in some cases may be a larger facility analogous to a conventional gas station. In an aspect, the present disclosure relates to a combined application of optimization, modeling, and forecasting to control one or more EV charging stations to reduce operational costs while maximizing earnings on EV charging. In an embodiment, earnings may consist or comprise revenue from EV charging minus expenses over the course of an optimization horizon. An optimization horizon may include the current time as well as a defined period into the future. In an embodiment, revenue may consist or comprise of revenue earned through sales of EV charging at the EV charging price, and expenses may consist or comprise of the energy cost. Earnings may be considered to be a function of one or more of the cost to the charging station operator of various sources of energy (optionally including depreciation of operator-owned energy assets), revenue generated by sale of charging services, and charging demand. Also, some other possible factors affecting earnings may include any additional revenue generated by participation in energy market programs, or a controlled degradation of battery lifespan of a battery ESS (BESS) via strategic charging and discharging.

In an aspect, the system automatically calculates an optimized dynamic price for EV charging to attempt to maximize earnings on EV charging. In an embodiment, the optimized dynamic price may directly or indirectly influence demand for EV charging, for example by communicating the price to EV users.

An EV charging station may include behind-the-meter distributed energy resource (DER) assets such as a BESS, rooftop solar cells, one or more wind turbines, a geothermal generator, or consumable-fuel-based generation units. The EV charging station may be connected to an electrical power grid, and may be configured to operate as a microgrid with an option to import power from the grid, export surplus power to the grid, or operate in “islanded mode” by disconnecting from the grid and operating using only local energy resources. Additionally, a charging station may make use of specific off-site energy sources, including renewables, via an independent power producer (IPP) contract or similar mechanism.

In an aspect, networks of EV charging stations under common or collaborative management may be coordinated by the EV charging management system to optimize net performance. Examples of such multi-station optimizations may include energy trading between entities subject to different energy purchasing agreements, optimization based on regional distribution congestion charges or limitations, and so forth.

In an embodiment, an EV charging management system may automatically control an EV charging price and EV chargers in a coordinated manner. Also, the system may forecast one or more of production and availability of local energy resources, and EV charging demand in the market, to intelligently optimize its control and pricing strategies. EV charging demand may refer to the demand at a specific EV charging station, or it may refer more generally to the demand in a defined geographical area, for example within a certain distance, in a neighborhood, or in a city, and so on.

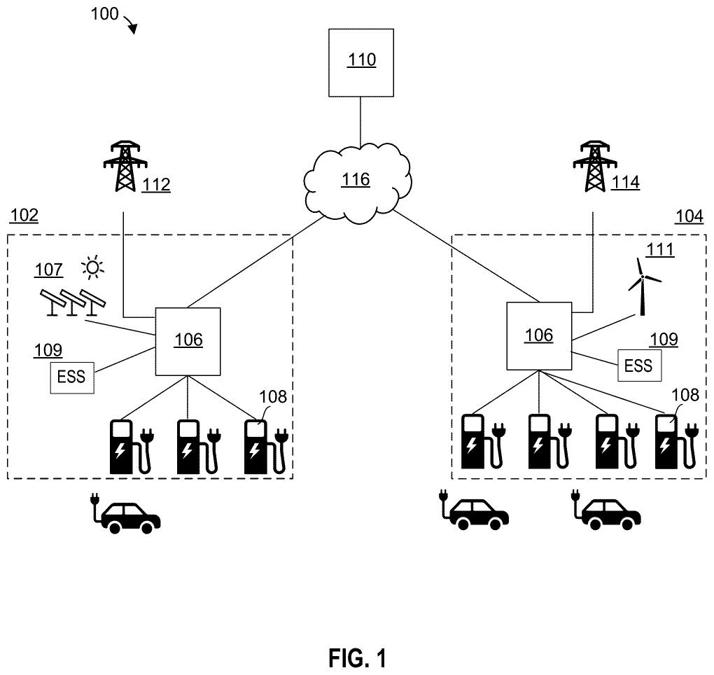

FIG. 1 is a block diagram of an example EV charging system 100. System 100 comprises two EV charging stations 102, 104, each having a controller 106, and one or more EV chargers 108. A charging station 102, 104 may optionally have one or more local renewable energy generation sources, such as solar panels 107 or wind turbines 111. Also, a charging station 102, 104 may optionally have one or more energy storage systems (ESS) 109. Further, a charging station 102, 104 may be electrically connected to a power grid 112, 114 for receiving energy for charging EVs, or optionally for providing energy to the power grid. Power grids 112, 114 may be the same or different power grids.

In addition, for controlling or managing system 100, system 100 comprises an EV charging management system 110 in communication with each EV charging station 102, 104. EV charging management system 110 and EV charging stations 102, 104 may be communicatively coupled in any suitable way(s), including via communication network(s) 116. In an embodiment, EV charging management system 110 could be partly or fully incorporated into an EV charging station.

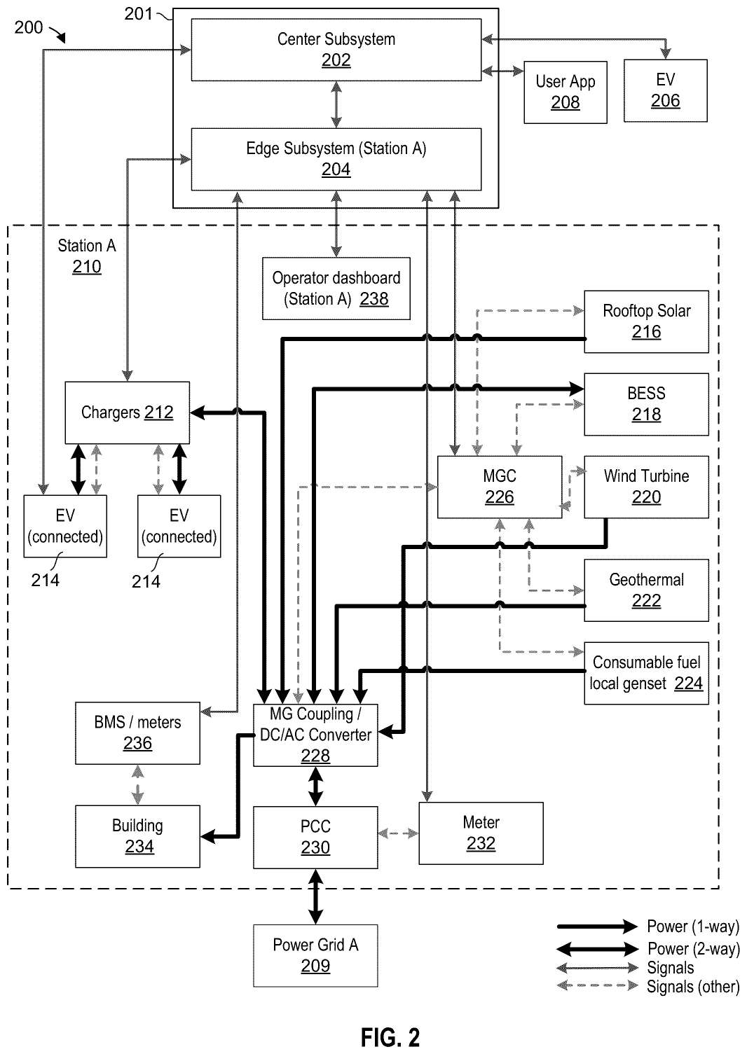

FIG. 2 is a block diagram of an example EV charging system 200 comprising an EV charging management system 201. EV charging management system 201 may communicate with one or more EV charging stations 210.

In this example embodiment, EV charging management system 201 comprises a center subsystem 202, which may be adapted to communicate with an edge subsystem 204 associated with an EV charging station 210.

In an embodiment, to support scalability, in that assets may be numerous and

perhaps geographically dispersed, a system according to the present disclosure may have a hierarchical structure, for example a center-edge architecture. In this regard, in an embodiment, the system may have a center subsystem and one or more edge subsystems. Some functions and features may be performed at the center subsystem while other functions and features may be performed at the edge subsystem(s). A center subsystem may serve as a point of common connection between disparate edge subsystems within a larger system. An edge subsystem may optionally be partially or entirely hosted on on-premises server hardware at an EV charging station. In an embodiment, at least part of the system may be implemented in a distributed internet of things (IoT) platform. In an embodiment, at least part of the system may be implemented in the cloud.

However, in other embodiments, EV charging management system 201 may not be subdivided into center and edge subsystems 202, 204. Accordingly, description herein of a component or module communicating with or being connected or coupled to center subsystem 202 or to edge subsystem 204 may be generally understood to mean that the component or module communicates with or is connected or coupled to EV charging management system 201.

Further, center subsystem 202 may also communicate with one or more other EV charging stations (not shown), for example via other edge subsystems (not shown) associated with those other charging stations.

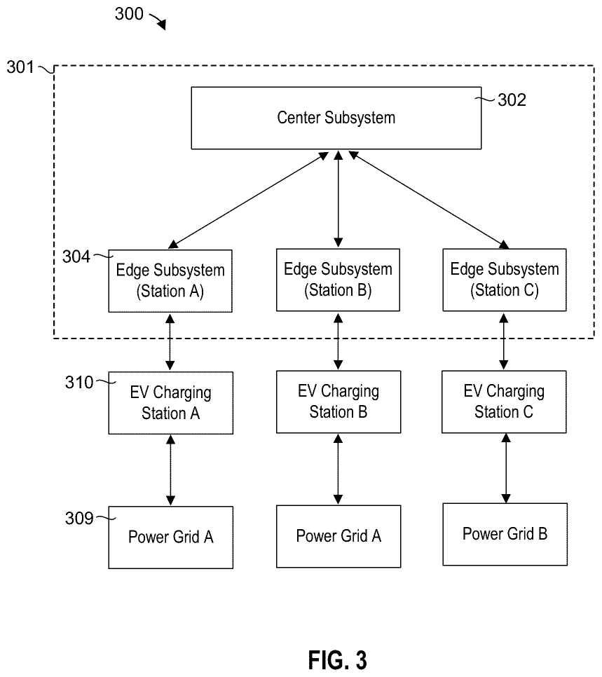

FIG. 3 shows an example EV charging system 300 having an EV charging management system 301 in communication with multiple EV charging stations 310. In this embodiment, EV charging management system 301 is shown as having a center subsystem 302 and an edge subsystem 304 for each of the EV charging stations 310. However, this is not meant to be limiting. In other embodiments, EV charging management system 301 may not be configured or subdivided into a center subsystem 302 and one or more an edge subsystems 304.

EV charging management system 301 may provide control and management of the various EV charging stations 310, and may do so in a coordinated manner. For example, system 301 may take into account the current states or other information relating to one or more EV charging stations 310. Further, EV charging station C is shown as being connected to a different power grid (power grid B) than EV charging stations A and B (power grid A) to illustrate the possibility of coordinated optimization of the network of EV charging stations spanning different power grids, potentially having different operating constraints and mechanisms affecting energy cost. In the case of multiple EV charging stations operating under the same interest whose objectives, for example maximizing earnings over time, are potentially conflicting with each other, for example by cutting into each other's demand for EVs charging, then the collective earnings over time or other objective of the EV charging stations altogether can be maximized or otherwise optimized by controlling the asset(s) at multiple EV charging stations accordingly.

Referring again to FIG. 2, EV charging station 210 (“station A”) comprises one or more EV chargers 212. An EV charger 212 may electrically connect to an EV 214 for charging the EV 214. Also, in an embodiment, in some circumstances, power may flow from the EV 214 to EV charging station 212, for example where “V2X” capabilities are enabled, such as vehicle-to-building (V2B), vehicle-to-vehicle (V2V), or vehicle-to-grid (V2G) power flow. Further, information in the form of signals may flow between EV charging station 212 and an EV 214 connected to EV charging station 212. For instance, telematics information associated with the EV 214 may provided to EV charging station 212. This information may include, for example, EV mileage and trip data, EV battery state of charge, or EV battery state of health.

A charger 212 may provide information relating to a connected vehicle, for example vehicle state of charge (SoC), flow of power, client or vehicle ID, or battery state of health (SoH), to EV charging management system 201. EV charging management system 201 may transmit a signal(s) to a charger 212 relating to timing of starting and stopping of charging, commanding or limiting power flow (charging), or commanding or limiting power draw (V2G/V2B).

Furthermore, in some embodiments, EV charging management system 201 is configured to communicate with an EV 214 when the EV 214 is not connected to an EV charging station 212. Such communications maybe performed over the air (OTA), meaning via wireless communication technology. An EV 214 may provide information relating to one or more of vehicle location and telematics, SoC, battery SoH, battery age or history, and vehicle mileage to EV charging management system 201. EV charging management system 201 may transmit a signal(s) to an EV 214 relating to, for example, one or more of price signals and station locations. This information may be provided to software application(s) on an EV infotainment system.

EV charging station 210 may comprise local renewable energy assets or sources, such as for example a solar power source 216, a wind power source 220, or a geothermal power source 222. Further, EV charging station 210 may comprise one or more non-renewable energy generation assets or sources 224, such as fuel powered electrical generator. Local renewable energy assets 216, 220, 222 may provide information relating to their power production to EV charging management system 201.

Non-renewable energy generation assets 224 may provide information relating to their power production or fuel levels to EV charging management system 201. EV charging management system 201 may transmit a signal(s) to non-renewable energy generation assets 224, or to any other suitable component of EV charging station 210, indicating that the assets 224 are to start or stop electrical energy generation.

Further, EV charging station 210 may comprise one or more ESSs, such as a BESS 218. BESS 218 may provide information relating to its state of charge or flow of power to EV charging management system 201. EV charging management system 201 may transmit a charging and discharging schedule to BESS 218 or other component of EV charging station 210.

Further, EV charging station 210 may comprise a microgrid controller (MGC) 226, which may be communicatively coupled with the various energy sources 216-224. A microgrid is generally a group of interconnected distributed energy resources and loads that acts as a single controllable entity in regard to a power grid. A microgrid can connect and disconnect to/from the grid to operate either in grid-connected mode or in island mode. MGC 226 may provide information relating to input passthrough from equipment controlled by the microgrid controller or a mode of the microgrid to EV charging management system 201. Modes of the microgrid may include one or more of islanded mode, exporting to the grid to a certain degree, or importing from the grid to a certain degree. EV charging management system 201 may transmit information to MSG 236 relating to output passthrough to equipment controlled by the microgrid controller, or to set a mode of the microgrid.

Further, EV charging station 210 may comprise microgrid coupling hardware 228, which could include DC/AC converter(s), to connect the various local energy sources or assets 216-224 as a microgrid. Further, EV charging station 210 may comprise a point of common coupling (PCC) 230 connecting the microgrid to a utility or facility electrical power grid 209 (“power grid A” in the figure). The connection of the PCC 230 to the power grid 209 may be metered with a meter 232. PCC 230 or meter 232 may provide information relating to EV charging station power draw from power grid 209, or EV charging station power export to power grid 209, to EV charging management system 201. EV charging management system 201 may transmit information to PCC 230 to set a mode of the microgrid.

Further, EV charging station 210 may comprise a base electrical load or loads associated with one or more on-site buildings 234. These load(s) 234 may be metered by a building management system (BMS) 236. BMS 236 may provide information relating to power consumption of station building subsystems of building 234 to EV charging management system 201. EV charging management system 201 may transmit information to BMS 236 relating to limiting power draw of controllable subsystems of building 234.

In this embodiment, center subsystem 202 may communicate with EV charging station 210 via edge subsystem 204. Edge subsystem 204 may afford control of and communication with one or more of local energy assets 216-224, building meters 236, grid connection hardware 230, EV chargers 212, and EVs 214 while they are connected to an EV charger 212. Edge subsystem 204 may be a cloud computing system.

Edge subsystem 204 may communicate with center subsystem 202, which may be a cloud computing system. Center subsystem 202 may host functions and datasets for the operation of system 200 and may serve as a common point of communication with other edge subsystem(s), or off-site physical or virtual system assets.

EV charging station 210 may comprise a user interface, for example in the form of an operator dashboard 238, which may be used to display or otherwise provide information relating to EV charging station 210 or relating to system 200. Dashboard 238 may be provided at any suitable computing device, for example at a computer at the EV charging station 210 or on a mobile or remote computing device. Dashboard 238 may receive, for example from edge subsystem 204 or center subsystem 202, the status and energy production of local distributed energy resources (DERs), forecasted local DER production, forecasted energy cost, forecasted demand, forecasted station mode schedule (island, import, export), or coordinated station network pricing. Dashboard 238 may provide, for example to edge subsystem 204 or center subsystem 202, local DER control, local charger control, or pricing controls and overrides.

Furthermore, a user interface 208 may be provided for use by a user of an EV. The user interface 208, or user application, may be provided at any suitable computing device, for example at a computer of EV 206 or on a mobile or remote computing device. User interface 208 may receive, for example from center subsystem 202, EV charging station location(s), charging station price of charging or price schedule, targeted price signals, or charger status and wait times. User interface 208 may provide, for example to center subsystem 202, a charging offer acceptance signal, device location, speed, direction, or vehicle/device connection status. Furthermore, EV charging management system 200 may communicate with EVs, for example to collect vehicle related information, for example useful for EV charging demand prediction, or to provide signals indicative of current or future EV charging prices or of other offers.

EV charging management system 200 may comprise one or more forecaster modules or subsystems for forecasting, predicting, or estimating certain types of values, data, or other information. A forecaster may be used to predict one or more of power grid energy cost, EV charging demand, weather conditions, amount of renewable power generation, or any other suitable type of data. Data from these forecasters may be fed into one or more optimizers, which may be adapted to determine an optimal price of charging. The optimal charging price may be determined on a rolling basis, that is, at regular intervals and optionally for a horizon of time into the future. Further, the optimizer may simultaneously determine actions and/or schedules for controllable energy assets, such as connected V2X-capable EVs, EV chargers or other pieces of electric vehicle supply equipment (EVSE), ESSs, generation systems (e.g., backup generators), or the export or import of electrical power to/from an power grid.

In an embodiment, a forecaster may be a machine learning based system, and thus may be trained using training data. The training data may include one or more of historical data and live data. A forecaster may be retrained at various points in time, for example on a regular basis or at any other intervals, in an attempt to improve its relevance and accuracy to current operations. A forecaster may be retrained using an ever-increasing supply of data that is incoming from live operations, and subsequently redeployed to continue providing forecasted information with improved accuracy. This may in turn provide for greater accuracy or efficiency of the output of the optimizer.

In an embodiment, the forecasted data may be used by an EV charging management system, for example to control one or more aspects relating to the EV charging, EV charging stations, or EV charging networks.

In the present disclosure, the center subsystem and edge subsystem(s) arrangement is provided as an example embodiment(s) but is optional. In some embodiments, the functions, operations, and/or structures of a center subsystem (e.g. 202) and an edge subsystem(s) (e.g. 204) may not be divided as between the two subsystems as shown and described. For example, some or all of the functions, operations, and/or structures of an edge subsystem may be located or performed at a center subsystem. Alternatively, some or all of the functions, operations, and/or structures of a center subsystem may be located or performed at an edge subsystem. Alternatively, a system could have only a single subsystem, which may have all of the functions, operations, and/or structures of both a center subsystem and edge subsystem described herein. Other configurations are also possible.

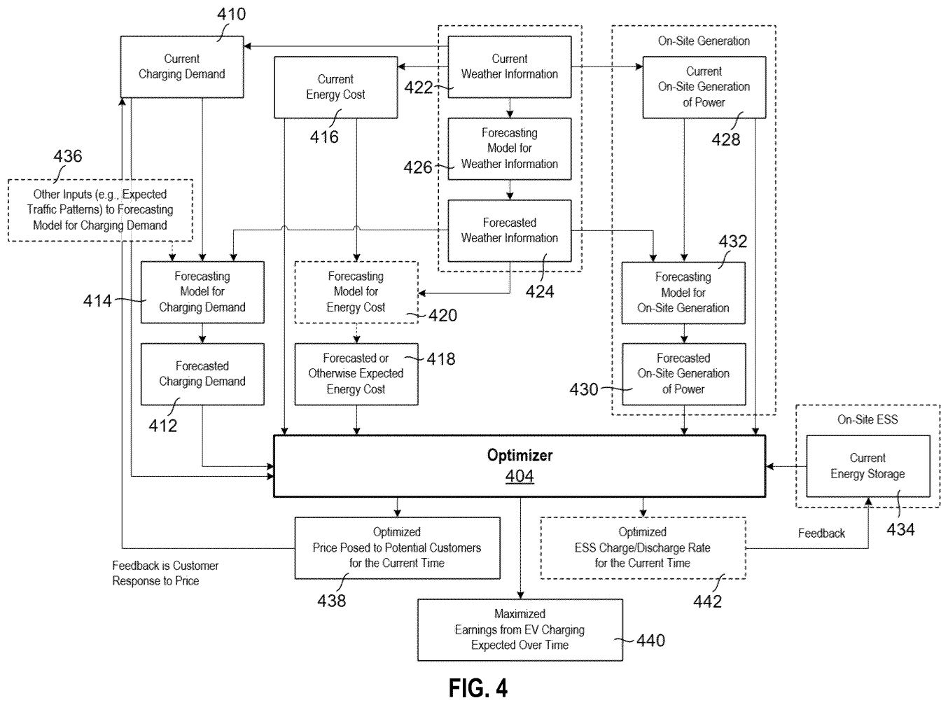

FIG. 4 is an information flow and block diagram in an example EV charging management system.

The EV charging management system may include or otherwise communicate with at least one other system or processing module 404, which may perform one or more of optimizations, calculations, functions, providing control, and providing management. For simplicity, but without limitation, this other system or processing module will be referred to as an optimizer 404 and its processing will be referred to as optimization. However, it is to be appreciated that optimizer 404 may perform any type of processing and is not limited to optimizations. In an embodiment, optimizer 120 may be configured for performing operations to optimize for one or more parameters in an optimization or control system.

Optimizer 404 may be configured for providing control or management in relation to an EV charging system. In an embodiment, the EV charging management system may be configured to optimize for one or more parameters relating to the EV charging system. In an embodiment, an optimizer may provide control in relation to a plurality of controllable assets within the EV charging system. In an embodiment, one optimizer may provide control of the controllable assets. In another embodiment, multiple optimizers may be used, and different optimizers may be used to control subsets of controllable assets. Other combinations and configurations are also possible.

Optimizer 404 may be a machine learning based system, which builds a model using training data. Optimizer 404 may take as input one or more of current or live data, and forecasted data provided by one or more forecasters. As a mere example, optimizer 404 may make decisions to optimize for one or more objectives for the EV charging system based at least in part on forecasted EV charging demand and forecasted energy cost. Descriptions of an optimizer receiving inputs generally means that the optimizer uses the inputs in performing the optimization.

Optimizer 404 may comprise one or more trained optimizers, which may be configured to solve one or more optimization problems related to the EV charging system, for example by minimizing or maximizing an objective function. The specific method or algorithm used to solve the optimization problem as the optimizer may depend on the exact formulation of the problem. Generally, an optimization algorithm does this by evaluating the objective function at a set of specific values of its decision variables (for example price points), and doing so for however many different values are necessary to be confident that a set of specific values achieves the objective among those from all possible values (even for which the objective function has not been evaluated) to within a pre-specified tolerance. The difference between optimization algorithms lies in how they obtain their initial set(s) of decision variable values, how they decide on subsequent decision variable values, and so on. An optimizer may be of any suitable type or types, for example: a linear programming optimizer, a mixed-integer nonlinear programming optimizer, a data driven optimizer, a stochastic programming optimizer, etc. Once an optimal value(s) of a decision variable is determined, assets may be controlled based on the optimal value, for example by providing the optimal value and/or indicating actions to assets. Further, optimal value(s) of the decision variable may be transmitted in a signal to one or more other computing devices, such as devices of EV users.

Controlling assets in the EV charging system may include performing an optimization in relation to those assets. Optimizations may relate to controlling one or more assets in the system such as EVs, EV charging stations, EV chargers, ESSs, and energy generation. Some examples of types of optimizations in a system may relate to scheduling of EV charging, minimizing cost of charging EVs, maximizing earnings on EV charging, maximizing the charging efficiency of EVs, increasing the use of certain types of energy such as locally generated renewable energy, etc. Other examples of types of optimizations are also possible.

In an embodiment, optimizer 404 may be configured such that a decision variable is the EV charging price posed to potential clients. The decision variable may be optimized by optimizer 404 with the objective to maximize earnings from EV charging. Optimizer 404 may take as input EV charging demand information, which may include current EV charging demand information and/or forecasted EV charging demand information. Further, optimizer 404 may take as input energy cost information, which may include current energy cost information and/or forecasted energy cost information. Energy cost information generally refers to the cost(s) for acquiring energy by the EV charging station. For example, if the EV charging station acquires energy from a local electricity power grid, the energy cost may be the cost to the EV charging station operator of buying that energy from the electricity power grid. Further, energy cost information may include cost(s) of energy acquired from other sources, such as renewable energy sources and non-renewable energy sources. These other sources may be located on-site or may be accessed in any other suitable way, for example via the grid through arrangements such as contracts with Independent Power Producers (IPPs). The cost(s) of acquiring energy from various sources can fluctuate over time, and may fluctuate based on various types of factors, such as time of day, day of week (for example work day, or weekend or holiday), and so on.

In an embodiment, the optimized value of the EV charging price may be transmitted in a signal to one or more other computing devices, such as an electrical or electronic public display at an EV charging station or along a roadway, or to devices of EV users. The EV charging price may affect client behavior, which may in turn affect the demand for EV charging. For instance, a relatively lower price may increase EV charging demand, while a relatively higher price may decrease EV charging demand. The EV charging price may be used to shift the EV charging demand in time.

In an embodiment, optimizer 404 may be configured to pursue one or more of the following example objectives, some of which may conflict with one another: maximizing earnings on EV charging at one EV charging station or across multiple EV charging stations, ensure grid stability using hard constraints, minimize carbon emissions from electricity generation, maximize utilization of renewable energy, and maximize generation of carbon offsets and/or renewable energy credits.

Maximizing earnings on EV charging at one or more EV charging stations may include minimizing costs of providing the EV charging, for example by using intelligent distributed energy resources (DERs) management, or by using intelligent exporting and importing of energy to/from a power grid. Further, maximizing earnings on EV charging may include using energy arbitrage techniques, or peak shifting using an ESS or EV battery assets.

In an embodiment, optimizer 404 may be configured with an objective to minimize the cost of energy used for EV charging. In this regard, a decision variable for the optimizer may relate to if and how to use one more assets, such as if and by how much to discharge energy from an ESS for EV charging or to charge an ESS using energy from the power grid, local renewable energy source(s), or local non-renewable source(s), if and by how much to use one or more local renewable energy sources for EV charging, how much energy to store in an ESS, and so on. As mere examples, one or more decision variables may comprise an ESS charge rate, an ESS discharge rate, an ESS charge/discharge schedule, an ESS energy level, or any other suitable variable.

In an embodiment, optimizer 404 may be configured with the objectives to maximize earnings from EV charging and to minimize the cost of energy used for EV charging.

Again, FIG. 4 is an information flow diagram in example EV charging management system. In this example embodiment, optimizer 404 is configured with an objective to maximize earnings from EV charging where a decision variable is EV charging price posed to clients. In an embodiment, potential clients may be EVs of a fleet that may be operated along with or separately from an EV charging station(s), for example an EV fleet owned and/or operated by a company that is different than or the same as the company that owns and/or operates the EV charging station(s); if a company owns and/or operates both the EV fleet and EV charging station(s), then there is a common financial interest that may be accounted for by the optimizer in its optimization performed for or on behalf of said company. In this embodiment, service agreements with fleet clients will enable more accurate demand predictions by the system for this class of client.

FIG. 4 shows various types of possible information, forecasters, and other features or components. Some optional features or components are indicated in FIG. 4 in dashed lines. However, other features and components may also be optional.

Various types of possible current values are shown, such as current charging demand 410, current energy cost 416, current weather information 422, and current on-site generation of power 428. The current value(s) may be those that are available at the current instance of time at which optimizer 404 is executed. The current value(s) may be provided as an input to optimizer 404.

Various types of possible forecasting models, or forecasters, are shown, such as a forecaster for charging demand information 414, a forecaster for energy cost information 420, a forecaster for weather information 426, and a forecaster for on-site generation of power information 432. A forecaster may comprise a computational model, for example a mathematical model, a machine-learning-based system, etc., that forecasts future values of the given quantities. These values may be forecasted over a defined horizon, which may overlap in time with the horizon used for optimization by the optimizer 404. An input to a forecaster may be its respective current value. In an embodiment, part or all of forecasted weather information may be obtained from a third party source.

Various types of possible forecasted values or information are shown, such as forecasted charging demand information 412, forecasted energy cost information 418, forecasted weather information 424, and forecasted on-site generation of power information 430. The forecasted value(s) or information may be provided as an input to optimizer 404.

Charging demand information may comprise current charging demand information 410 and/or forecasted charging demand information 412. EV charging demand, for example the demand of EV users to charge EVs, for example at a given EV charging station, and by how much, may be expressed in units of electrical power, for example in kilowatts. This demand is the amount of power to be delivered by and drawn from the charger(s) of the EV charging station, and thus from the on-site electrical infrastructure of the EV charging station itself. This quantity may be a numerical value that may be expected to change over time. The quantity may express or indicate one or more of the following: a number of EVs at the given EV charging station; whether or not an EV is actively charging; how quickly an EV is charging, meaning the rate of charging (also in units of electrical power); and the probabilities of these (in the case of forecasted values). Generally, a forecaster for EV charging demand 414 may incorporate user choices and behavior. Further, a forecaster for EV charging demand 414 may incorporate other information 436 as input such as estimated traffic patterns, for example in a geographical area around the given EV charging station. Further, a forecaster for EV charging demand may include or use modeling of behavior patterns of known clients or client types. Charging demand information may be provided as an input to optimizer 404.

Energy cost information may comprise current energy cost information 416 and/or forecasted energy cost information 418. Energy cost information may comprise the cost of one unit of electrical energy, for example the cost of one kilowatt-hour, drawn by a given EV charging station from the power grid over a given span of time. The cost may be set by an electrical company or operator of the power grid. Energy cost may change as a mathematical function of time, for example with time of day, and/or day of week, in the short term, for example based on a time-of-use pricing scheme by the electrical company or operator of the power grid. Further, energy cost may change with billing rate changes in the longer term. However, in some instances, energy cost may not necessarily fluctuate continuously with time. A forecaster for energy cost information 420 may use information such as time of day, total amount of energy used in a timeframe, peak power drawn within a timeframe, time-of-use, changing wholesale rates, coincident peak pricing, delivery or transmission charges linked to energy use or peak demand, congestion charges, other programs and incentives, and/or any other suitable information. Energy cost information may be provided as an input to optimizer 404.

On-site power generation information may comprise current on-site power generation information 428 and/or forecasted on-site power generation information 430. On-site power generation may refer to behind-the-meter energy resources, meaning behind the power grid meter. The supply of electric generation provided by energy sources and assets that are located at or proximate to a given EV charging station, for example a wind turbine, solar panel, and so on, may be expressed in units of electrical power, for example in kilowatts. On-site power generation may be affected by weather, for example in the cases of solar and wind. However, other types of generation may not be as weather dependent, such as a geothermal well, whose power output may otherwise be time-dependent. On-site power generation information may be provided as an input to optimizer 404.

Weather information may comprise current weather information 422 and/or forecasted weather information 424. Weather information may include, for example, information representing one or more of temperature, humidity, wind speed, cloud cover, precipitation, and so on. Weather may affect EV charging demand, energy cost, and on-site generation of power. For example, extreme wind speeds may decrease the charging demand because potential clients chose to charge their EVs at their own homes; a combination of extreme temperature and humidity may increase the energy cost because the grid operator choses to discourage excessive air conditioner use to avoid blackouts; or low wind speeds or high cloud cover may decrease the on-site generation of power if present in the form of a wind turbine or solar panel, respectively. In an embodiment, current weather information 422 may be provided as input to, or otherwise affect, one or more of current charging demand 410, current energy cost 416, and current on-site generation of power 428. In an embodiment, forecasted weather information may be provided as input to one or more of forecaster for charging demand 414, forecaster for energy cost 420, and forecaster for on-site generation of power 432.

On-site ESS information 434 may include current energy storage of the ESS. On-site ESS information 434 may be provided as an input to optimizer 404.

Optimizer 404 may include a method of optimization, for example a mathematical method, a computational algorithm, etc., as well as a mathematical formulation of an optimization problem. EV charging stations may be configured with the same or different optimization problems. Further, an optimization problem may be applied to a group of multiple EV charging stations. In an embodiment, a decision variable may be a variable price point for EV charging. A mathematical formulation may include one or more constraints on the optimization problem, and the total earnings may be expressed as a mathematical function of the price points to pose to potential clients. In an embodiment, the mathematical function may include charge/discharge rates of an on-site ESS, which also may be considered as decision variables. An optimization may be performed for an optimization horizon, which may include the current time or solely be the current time.

In an embodiment, optimizer 404 takes an input charging demand information and energy cost information. In an embodiment, optimizer 404 may take as input on-site power generation information and/or on-site ESS information.

Optimizer 404 is executed to determine an optimal (or “optimized”) price point for EV charging 438 that maximizes earnings from EV charging 440 over the optimization horizon. In an embodiment, optimizer 404 may run the mathematical formulation multiple times at multiple different values of the decision variable, here a price point for EV charging, in order to determine the optimal price point that maximizes earnings from EV charging. The price may be a price of one unit of electrical power, for example one kilowatt, drawn by an EV at an EV charging station. An optimal price point for EV charging 438 may be transmitted in a signal to any suitable computing device(s), for example to an electrical or electronic display at the EV charging station (for example similar to sign posts at conventional gasoline stations), or to computing devices of EV users, which in turn may affect current and/or forecasted EV charging demand 410, 412. Further, an optimal EV charging price 438 may affect EV charging demand, which in turn may affect future optimal pricing for EV charging, and so on. This is a form of feedback within the system between EV charging demand, which is influenced by EV users, and one or more EV charging stations.

Maximized earnings from EV charging 440 may be outputted from optimizer 404.

EV charging price information may be transmitted in a signal(s) through one or more different channels, and may be broadcasted publicly or targeted to individual clients. Such signals may be transmitted by or at the request of the EV charging management system. EV charging price information may include a base price of charging, which may be updated periodically for broadcasting, for example to the public.

Further, EV charging price information may include a targeted EV charging price to incentivize a specific client, for example via an opt-in channel such as a client mobile application running on a computing device. A targeted price is a price optimized specifically for a potential client or class of client, and may be based on parameters indicative of their probability of responding to the price signal with a decision to purchase (e.g. client location, or client EV state of charge). Further, EV charging price information may include a targeted EV charging price coupled with a requirement for a client to confirm an intent to charge at a certain location within a certain time, for example via a mobile application or other service on a computing device, for example in order to benefit from an EV charging price incentive.

Targeted EV charging prices may be optimized to influence demand with faster response times and/or higher certainty than a publicly broadcasted price. Incentives may be structured around typical client behaviors recorded through use of services, the location data of connected device(s), vehicle telematics, or other relevant methods. Client confirmations in response to targeted price signals, possibly along with their current locations, may be used as inputs to EV charging demand forecasters to improve short-term accuracy and thereby enhance the performance of the charging price optimization.

The EV charging management system may optionally set pre-purchase EV charging prices targeted to EV fleet operators, offering charging services in volume, optionally on a ‘use-it-or-lose-it’ basis. In the event that a fleet client fails to use their allotment of charging capacity, surplus energy may be fed into local ESS or incorporated in an energy market response. EV charging demand implied by pre-purchased charging agreements may be used as a high-confidence input to an EV charging demand forecaster to have greater-than-otherwise accuracy and thereby enhance the performance of the EV charging price optimization.

Energy buyback may be implemented in a similar manner for EV charging stations incorporating V2X capabilities. Energy buyback generally refers to the purchasing of energy stored in an EV, for example by an EV charging station. Signals may be transmitted by the EV charging management system indicating an energy buyback price as a fixed rate per unit of electrical energy or as a function of time and/or the amount of energy that would be consumed. A buyback price signal may be optimized or otherwise calibrated to incentivize potential clients that own EVs to connect their EV to a V2X capable charger at an EV charging station to enable the EV battery to act as a local energy resource for a period of time. Potential targets for such an energy buyback program may include, for example, medium or heavy-duty fleet operators whose vehicles see sporadic or seasonal utilization dips. A mere example is electric school buses.

As noted above, EV charging price information may be transmitted in a signal(s) through one or more different channels. The EV charging management system may automatically transmit EV charging price signals, collect client responses to confirmation-dependent price signals, and/or collect information on clients and their EVs to inform forecasting and optimization models and algorithms.

In an embodiment, a software application running on a computing device may transmit one or more of device location, speed, and direction information to the EV charging management system. This information may be used as input to an EV charging demand forecaster, to inform price signals, or may be stored in a database for other purposes, for example as a component of a client behavior profile. Further, the software application may display public or targeted EV charging price information on a display of the device for viewing by the client, with an option for client input of a confirmation signal confirming acceptance of an EV charging price. Further, the software application may display geographical locations of EV charging stations that are nearby the current location of the device, or near the client's intended route. This information may include current or future EV charging prices at the given EV charging station. The EV charging station location information and related information may be displayed via integration with a third-party navigation application.

The EV charging management system may include or communicate with an EV telematics service to collect telematics information directly from client EVs. This may be done using any suitable communication means, for example via a long term evolution (LTE) communications, or other wireless or wired communications technologies. The collected information may include, for example, one or more of the following: EV location and telematics (e.g., speed, direction), state of charge (SoC) of EV batteries, state of health (SoH) of EV batteries, EV battery age and history, and vehicle mileage.

Any of the collected information may be used as input to the EV charging demand forecaster and/or stored in a database for other purposes, for example to inform client behavior profiles. Further, EV location and telematics information may be used to inform price signals. Further, the telematics service may be configured to transmit EV charging price signals to onboard original equipment manufacturer (OEM) software applications in EVs.

Furthermore, when an EV is connected to an EV charger at an EV charging station, the EV charger may collect information from the EV. Example types of information that may be collected include one or more of EV battery SoC, EV battery SoH, EV battery age and/or history, vehicle mileage, charge session start/stop times, and transaction data (for example amount of energy purchased/transferred, maximum charge rate, etc.). This information may be used for similar purposes to the data collected from EV telematics.

A public broadcast of a signal indicative of EV charging price information may indicate a current or projected EV charging price. The EV charging management system may transmit, or cause to be transmitted, a public broadcast, for example to internet connected software applications on computing devices, to application programming interfaces (APIs), or via any other suitable channels.

In an embodiment, the EV charging management system may comprise one or more emulators/simulations/models of EV charging station assets. An emulator may be configured to forecast the long-term degradation characteristics of an asset, for example battery degradation resulting in a decreased battery capacity. Degradation may be factored in as a cost component, or expense, in a calculation of EV charging earnings. For example, an on-site BESS will degrade through repeated charge and discharge cycles, compromising performance and eventually requiring repair or replacement of the BESS. This degradation may be simulated or otherwise modeled by the emulator based on operation of the BESS so that the cost of degradation may be considered by optimizer.

The EV charging management system may communicate with one or more databases storing information. The information may include, for example, information collected from various assets coordinated by the EV charging management system, such as EV chargers, ESSs, energy generation assets, and so on. Further, the stored information may include user information collected from client software applications or other sources, weather, traffic, and/or energy market information. The database may be used to build and maintain client behavior profiles, train machine learning models and algorithms involved in the operation and optimization of an EV charging station or network of EV charging stations.

The EV charging management system may enable or coordinate participation in energy market programs. An EV charging station or a network of EV charging stations may communicate with utilities or independent system operators (ISOs) to make bids or offers as an energy market participant. Energy market programs may include operating reserve or demand response functions (or similar) where available. Actions by an EV charging station or a network of EV charging stations to participate in a market may include reduction of electricity drawn from a power grid, or exporting to the power grid of available surplus energy. Both actions may be realized via induced reduction of demand through EV charging price adjustment, discharging of energy from local ESS, or use of local energy generation.

Revenues from energy market participation may be factored into an optimization of EV charging earnings. Energy market participation may result in a consequent adjustment of EV charging prices to reduce demand and to create availability of surplus energy during times when it is may be advantageous to do so. A decision to transmit such a market participation bid or offer to the responsible power grid entity may be made automatically in an optimized manner by the EV charging management system.

In an embodiment, an optimizer may be configured with another decision variable(s) in the form of the charge/discharge rates of an ESS (which may or may not be located on-site at the EV charging station). Optimizer 404 may be executed to determine optimal charge/discharge rates of an ESS 442 that maximizes earnings from EV charging 440 over the optimization horizon.

The rate at which energy is transferred into or out of an ESS at the current time, for example from the current time until the optimization is executed again, may be expressed in units of power, for example one kilowatt. An optimal ESS charge/discharge rate for the current time may be used to control the ESS and may affect what will become the next amount of energy stored in the ESS, which may also depend on the amount of energy in the ESS before the current charging/discharging. Although the terms “charge” and “discharge” are used, the ESS need not be a BESS, meaning it does not necessarily include a battery. Thus, the terms “charge” and “discharge” used in reference to an ESS generally mean adding energy to the ESS and removing energy to the ESS, respectively. Optimal charge/discharge rates of an ESS 442 may be transmitted in a signal, for example to the ESS or elsewhere, for example to provide some control over the operation of the ESS. Control of the ESS may include times or schedules for charging and discharging, charging and discharging rates, and so on.

Optimizer 404 may perform its optimization or other calculation or processing at any suitable times, for example periodically, at non-uniformly spaced time periods, and/or in response to triggering events. For example, the optimization or other calculation or processing may be performed every x second(s), every x minute(s), every x hour(s), or any other suitable time intervals. For instance, the optimizer could be executed every 5 minutes, 15 minutes, 30 minutes, 60 minutes, 2 hours, 3 hours, or at any other times. An example triggering event may be when a parameter exceeds above or drops below a defined threshold, or when a signal is received.

Further, according to an aspect, optimizer 404 may execute in real-time or near real-time. The optimization may be based on real-time, near real-time, and/or streaming data inputs, such as one or more of current EV charging demand, current energy cost, current weather information, current on-site power generation, and any other suitable type of current information.

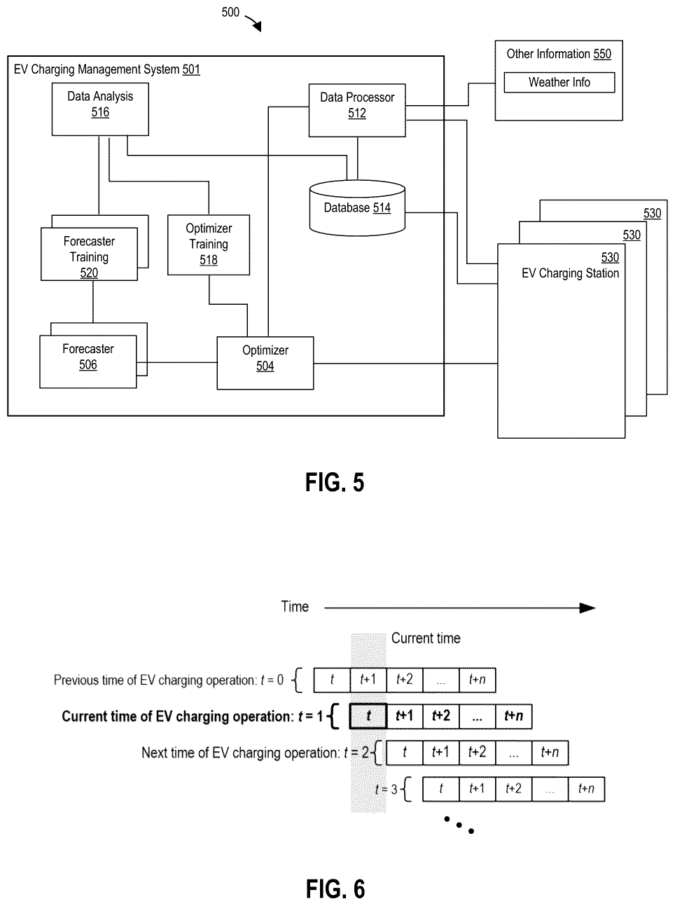

FIG. 5 is a block diagram of an example EV charging system 500 comprising an EV charging management system 501. FIG. 5 is generally intended so show some example modules or subsystems of EV charging management system 501.

EV charging management system 501 may receive various types of information from various sources. The data or other information may be historical data and/or live data. For example, EV charging management system 501 may receive information 550, such as weather related data and/or geo data, or any other suitable information. This information may be generally referred to as environment data, although other types of information may also be included. Further, other types of environment data may include, for example, information on renewable energy generation and availability, energy grid operational parameters, electric vehicle and/or vehicle depot information, energy market information, route manager information relating to vehicles, renewable energy information, energy cost information, or any other suitable type of information.

Further, EV charging management system 501 may receive information from one or more EV charging stations 530. This may be any type of suitable data or information available at an EV charging station 530, including any of the various types of information described herein. This may include EV telematics information, other EV data such as battery SoC, battery SoH, EV mileage, EV user preferences and habits, on-site power generation information, ESS information, and so on. In an embodiment, at least some of the information may be streaming data, real time data, and/or live data.

Data processor 512 may perform data cleaning, data warehousing or other operations on received data. Data received by data processor 512 may be cleaned, conditioned, or otherwise modified. Data processor module 512 may transform data into a format more suitable for machine learning techniques, such as supervised learning. Data from data processor 512 may be provided to another module(s), such as database 514 or optimizer 504.

Data and other information may be stored in one or more repository databases, for example database 114. The stored data may include historical data and so on. A database may comprise one or more databases stored on one or more computing devices.

Data, for example from database 514, may be provided to data analysis module 516. Data analysis module 516 may be configured to perform one or more of data processing and feature selection, for example for the purposes of preparing training data for use by a forecasting training module 520 or optimizer training module 518.

Forecaster training module 520 may train one or more forecasters 506. Optimizer training module 518 may train optimizer 504. The training data used for the training may comprise historical data.

One or more forecasters 506 may be used for forecasting information, such as EV charging demand, energy cost, weather information, on-site power generation, and so on. Forecasted information may be provided to optimizer 504.

Optimizer 504 may be used to perform optimizations, as herein described. Output of optimizer 504 may be provided to one or more charging stations 530, and/or used at EV charging management system 501.

A simplified example of some operations of an EV charging management system is now described. Consider a single EV charging station that is connected to an electrical power grid. In terms of physical assets, the EV charging station is equipped with solar panels for on-site generation and a BESS for on-site energy storage. In terms of business intelligence assets, the EV charging management system includes forecasters and an optimizer. Firstly, consider that the current time in the station's operation is 1 pm on a business day and the weather is sunny. The cost per kWh of electricity drawn from the grid is relatively expensive, the on-site solar generation is high, and the EV charging demand is low.

Based on a forecasted EV charging demand, the optimizer may set the EV charging price per kW to an optimal value that is relatively low to maximize EV charging earnings by attracting an EV charging demand to better meet the supply of inexpensive solar and grid energy that could otherwise be lost. This example of optimization is instantaneous, meaning that it is done for a single moment in time. A consequence of this is that the BESS cannot be controlled such that levels of energy stored therein are maintained over time for later use.

Now, consider that at the same time of 1 pm, forecasters of the EV charging management system forecast the following: at 8 pm on the same day, the grid cost will be relatively inexpensive, the on-site solar generation will be low, and the EV charging station will be at capacity because of high EV charging demand. The forecasters may have calculated their forecasts based on historical data, the current situation at 1 μm, and weather forecasts made at the time for 8 pm. If the optimizer considers these forecasts, and plans into the future, it may decide to set the EV charging price at 1 μm to an even lower price than what would be optimal for the EV charging earnings at 1 pm exclusively. By doing this, the optimizer may increase the EV charging demand at 1 pm, where some EV users may have otherwise planned to charge their EVs later in the evening only to find at 8 pm that the EV charging station is at capacity. Thus, the optimizer adjusted the EV charging price for 1 pm to shift demand that is forecasted for 8 pm to 1 pm to take advantage of the surplus of demand at 8 pm and the surplus of inexpensive energy at 1 pm.

If the optimizer both plans into the future and controls the BESS accordingly, then it may decide to charge the BESS at 1 pm for later use instead of setting a low price that is not necessarily conducive to maximizing EV charging earnings at 1 pm. Thus, the optimizer may adjust the EV charging price to shift EV charging demand to times that are optimal for a longer-term maximized EV charging earnings. Further, the optimizer may simultaneously control an on-site ESS to shift a supply of energy to times that are optimal for a longer-term maximizing of EV charging earnings. Furthermore, the optimizer may be executed on an hourly basis, or at any other desired intervals, to leverage recent data for its optimization, and continue to plan into the future.

A timespan over which earnings from EV charging is maximized may be the current instance in time of the EV charging operation, in which case only one earnings period is maximized, using current information, by optimizing a variable EV charging price at the current time instance.

In another embodiment, a timespan for optimization may include an optimization horizon, meaning into the future. The horizon may include the current time and one or more times into the future. A sum of earnings at the instances of time within the horizon is maximized, using forecasted information, by optimizing an EV charging price at each of the times within the horizon. For instance, within the horizon, the optimizer may optimize for the variable EV charging price as follows: at t=0, price=A; at t=1, price=B; at t=2, price=C, and so on. In an embodiment, the optimizer may also optimize the amount of energy stored in an ESS at each of the times within the horizon. The optimal EV charging price for the current time may be used by the EV charging station. However, while optimal prices for EV charging at future points in time in the horizon are determined, these prices would not necessarily take effect because subsequent uses of the optimizer in the future using more recent and more accurate information may different optimal prices for EV charging.

FIG. 6 is a diagram showing an example receding horizon optimization arrangement. An optimizer may be used at multiple moments over time in a receding horizon optimization arrangement, with an initial use followed by subsequent uses to update the prices for EV charging that had been planned by previous optimizer uses. For example, in FIG. 6, the optimizer is executed at time t=0 to determine optimal prices for EV charging for times t, t+1, t+2, up to t+n. Later, the optimizer may be executed at time t=1 to determine optimal prices for EV charging for times t, t+1, t+2, up to t+n.

From one use of the optimizer to a subsequent one, a fixed point in time in the future for which information is forecasted becomes closer and thus the information made available for that point in time may become more accurate, particularly if that point in time is the current time and the associated information is then observed rather than forecasted. Having more accurate forecasts, and observations when applicable, may mean that the optimized price point will more accurately yield a maximized earnings from EV charging over time.

Optimizing for EV charging price at multiple points in time individually is not necessarily equivalent to optimizing multiple points in time simultaneously as part of one, unified objective of the optimizer. For example, a sum of maximized earnings over time using the former may be less than a sum of maximized earnings over time of the latter. By leveraging the simultaneous optimization of future prices for EV charging, profit margin limits that are imposed by on-site generation at one point in time may cancel out, in part or in whole, with the profit margin limits imposed at another point in time due to EV charging station throughput; the former untapped surplus of charging demand and/or the latter untapped surplus of energy supply may be shifted in time to coincide with each other. A receding horizon optimization of prices, and optionally ESS storage, may enable peaks in charging demand and surpluses of available energy supply to be shifted to align with each other at the same points in time, or to be spread out over time, to further maximize total earnings from EV charging. A similar approach may enable a charging station to provide peak-shifting and peak-shaving services to a power grid as an additional optimization objective. Provision of these services may be synergistic with EV charging station optimization in terms of reducing the energy cost of energy from a power grid that may be incurred by such peaks if power has to be drawn from the power grid.

Further, an example of shifting charging demand and energy supply is provided as follows. At a future time t1 in the optimization horizon, that time's profit margin and thus the sum of profit margin over time happens to be limited by a lack of on-site generation rather than the throughput of the EV charging station itself at t1. This would represent a surplus of the demand for charging EVs that would be unused because there is an insufficient supply of energy at that time to meet that demand. At a future time t2, however, that time's profit margin instead happens to be limited by the EV charging station throughput rather than the on-site generation at t2. This would represent a surplus of the supply of energy that would be unused because there is an insufficient amount of demand that is able to be fulfilled by the station to use the extra energy supply. By using a variable pricing schedule and/or an ESS charge-and-discharge schedule expected to be optimal according to a receding horizon optimization that is knowledgeable of the forecasted situations at t1 and t2, the surpluses of charging demand and energy supply may be partially or fully shifted to match in both quantity and in time such that they, in effect, “cancel out”. This may take the form of lower-than-otherwise prices at t1 and/or higher-than-otherwise prices at t2 incentivizing customers of the EV charging station to charge at t1 instead of t2. It may also take the form of an ESS discharging at t1 and charging at t2. By enacting some or all of these potentially optimal decisions, momentary limits on the profit margin can be overcome through the use of receding horizon optimization, which is an example of an arrangement of EV charging station optimization.

An optimizer may be configured to minimize or otherwise meet goals for reducing greenhouse gas (GHG) emissions from energy generation, be they from on-site and/or offsite sources. For example, a limit on maximum allowable GHG emissions may be set as a hard constraint for the optimization of earnings, or a cost of GHG emissions (for example a monetary value per kilogram of carbon dioxide emitted) may be factored into the formulation of the optimization problem. Such a cost of GHG emissions (or monetary gains associated with curtailing GHG emissions) may relate to relevant subsidies, incentives, or other programs (for example carbon taxes) implemented by the jurisdiction or government under which the EV charging station(s) or its company operates, or they may relate to policies implemented by the operating company of the EV charging station(s). Such a cost of GHG emissions may also reflect the behavior of those EV owners who are environmentally aware as potential clients of the EV charging station(s). Further, minimizing GHG emissions may be set as the sole objective of the optimizer(s) or as an additional objective alongside that of maximizing earnings, in which case a balance or “middle ground” may be determined between the two potentially conflicting objectives. Also, the environmental impact of an ESS or other physical assets related to EV charging station operation may be accounted for in a similar fashion to GHG emissions.

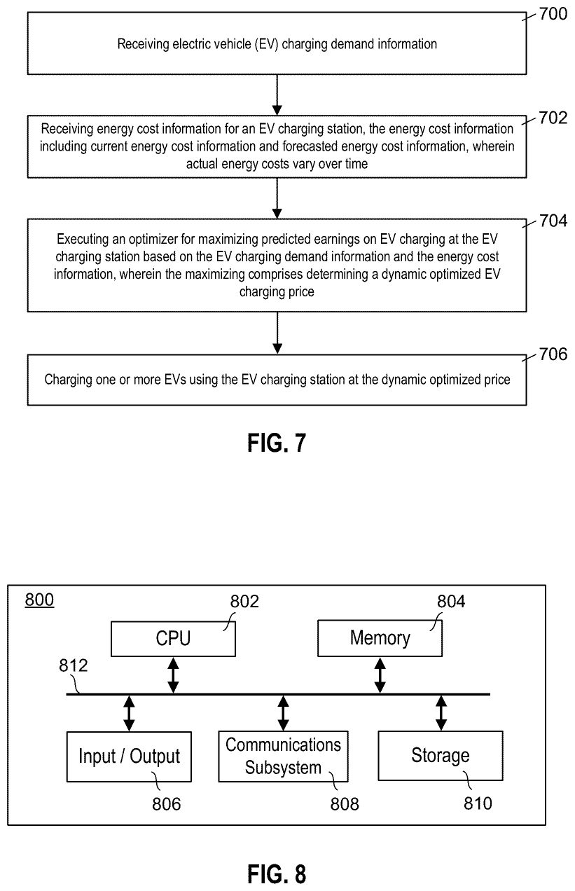

FIG. 7 is a process flow diagram of an example method. The example method may be performed at or by one or more electronic devices each having one or more hardware processors and computer-readable memory.

At block 700, the process involves receiving electric vehicle (EV) charging demand information.

At block 702, the process involves receiving energy cost information for an EV charging station. The energy cost information may include current energy cost information and forecasted energy cost information. The actual energy costs may vary over time.

At block 704, the process involves executing an optimizer for maximizing predicted earnings on EV charging at the EV charging station based on the EV charging demand information and the energy cost information. The maximizing may comprise determining a dynamic optimized EV charging price.

At block 706, the process involves charging one or more EVs using the EV charging station at the dynamic optimized price.

In some embodiments, algorithms, techniques, and/or approaches according to the present disclosure may be performed or based on artificial intelligence (AI) algorithms, techniques, and/or approaches. This includes but is not limited to forecasters and/or optimizers according to the present disclosure, as well as controlling of controllable assets.

In some embodiments, the AI algorithms and techniques may include machine learning techniques.

Machine Learning (ML) may be used in power or energy systems, including EV charging management systems, with penetration of renewable energy such as wind, solar, or tidal energy, to improve the utilization of variable renewable resources and coordinate consumption and demand. Machine learning systems may be used to forecast information associated with one or more assets for example EV charging demand, energy cost, weather information, or on-site power generation. Machine learning models may be used, as a mere example, to predict future resource availability and demand requirements, and/or control assets in a system, for instance using one or more optimizations. Forecasters or predictors may be used to control or schedule charging interactions, to schedule EV charging, energy generation, storage, and/or pricing to optimally coordinate these energy systems to achieve one or more objectives such as cost minimization, earnings maximization, efficiency maximization, or optimal use of local renewable energy. Further, forecasters and/or optimizers, and the training thereof, may also use or be based on machine learning techniques.

A machine learning algorithm or system may receive data, for example historical data, streaming controllable asset data, environmental data, and/or third party data, and, using one or more suitable machine learning algorithms, may generate one or more datasets. Example types of machine learning algorithms include but are not limited to supervised learning algorithms, unsupervised learning algorithms, reinforcement learning algorithms, semi-supervised learning algorithms (e.g. where both labeled and unlabeled data is used), regression algorithms (for example logistic regression, linear regression, and so forth), regularization algorithms (for example least-angle regression, ridge regression, and so forth), artificial neural network algorithms, instance based algorithms (for example locally weighted learning, learning vector quantization, and so forth), Bayesian algorithms, decision tree algorithms, clustering algorithms, and so forth. Further, other machine learning algorithms may be used additionally or alternatively. In some embodiments, a machine learning algorithm or system may analyze data to identify patterns and/or sequences of activity, and so forth, to generate one or more datasets.

An EV charging management system may comprise one or more control policies. The control policies of the system may be based on trained machine learning based systems. In this sense, a control policy may be part of a control agent. A control agent observes its environment, herein referred to a control environment, and takes action based on its observations, or percepts, of the control environment. The taking of action is referred to as controlling the system. Depending on the state of the environment, taking action may involve taking no action at all, for example if there has been little or no change in the state since the last time the agent took action. Thus, doing nothing is a valid action in a set of actions in the action space of the controller. In an embodiment, the present systems and methods may exploit the flexibility of controllable assets in the power system to achieve improved performance of the system. For example, the flexibility of controllable assets may be exploited in response to changes in the control environment.

In an embodiment, online machine learning may be employed. Online machine learning is a technique of machine learning where data becomes available sequentially over time. The data is utilized to update a predictor for future data at each step in time (e.g. time slot). This approach of online machine learning may be contrasted to approaches that use batch learning wherein learning performed on an entire or subset of training data set. Online machine learning is sometimes useful where the data varies significantly over time, such as in power or energy pricing, commodity pricing, and stock markets. Further, online machine learning may be helpful when it is not practical or possible to train the agent over the entire or subset of data set.

In embodiments according to the present disclosure, training of a machine learning system, such as an forecaster or optimizer, may be based on offline learning and/or online learning where streaming real-time data may be combined with at least some data, for example from a database to train the machine learning system in real-time or near real-time.

FIG. 8 is a block diagram of an example computerized device or system 800 that may be used in implementing one or more aspects or components of an embodiment according to the present disclosure. For example, system 800 may be used to implement a computing device or system, such as an optimizer, forecaster, or controller, to be used with a device, system or method according to the present disclosure. Thus, one or more systems 800 may be configured to implement one or more portions of the systems or apparatuses of FIGS. 1-5. This includes an EV charging management system.

Computerized system 800 may include one or more of a computer processor 802, memory 804, a mass storage device 810, an input/output (I/O) interface 806, and a communications subsystem 808. A computer processor device may be any suitable device(s), and encompasses various devices, systems, and apparatus for processing data and instructions. These include, as examples only, one or more of a programmable processor, a computer, a system on a chip, and special purpose logic circuitry such as an ASIC (application-specific integrated circuit) and/or FPGA (field programmable gate array).

Memory 804 may be configured to store computer readable instructions, that when executed by processor 802, cause the performance of operations, including operations in accordance with the present disclosure.

One or more of the components or subsystems of computerized system 800 may be interconnected by way of one or more buses 812 or in any other suitable manner.

The bus 812 may be one or more of any type of several bus architectures including a memory bus, storage bus, memory controller bus, peripheral bus, or the like. The CPU 802 may comprise any type of electronic data processor. The memory 804 may comprise any type of system memory such as dynamic random access memory (DRAM), static random access memory (SRAM), synchronous DRAM (SDRAM), read-only memory (ROM), a combination thereof, or the like. In an embodiment, the memory may include ROM for use at boot-up, and DRAM for program and data storage for use while executing programs.

The mass storage device 810 may comprise any type of storage device configured to store data, programs, and other information and to make the data, programs, and other information accessible via the bus 812. The storage device may be adapted to store one or more databases and/or data repositories, each of which is generally an organized collection of data or other information stored and accessed electronically via a computer. The term database or repository may thus refer to a storage device comprising a database. The mass storage device 810 may comprise one or more of a solid state drive, hard disk drive, a magnetic disk drive, an optical disk drive, or the like. In some embodiments, data, programs, or other information may be stored remotely, for example in the cloud. Computerized system 800 may send or receive information to the remote storage in any suitable way, including via communications subsystem 808 over a network or other data communication medium.

The I/O interface 806 may provide interfaces for enabling wired and/or wireless communications between computerized system 800 and one or more other devices or systems, such as an electric vehicle charging system. Furthermore, additional or fewer interfaces may be utilized. For example, one or more serial interfaces such as Universal Serial Bus (USB) (not shown) may be provided. Further, system 800 may comprise or be communicatively connectable to a display device, and/or speaker device, a microphone device, an input device such as a keyboard, pointer, mouse, touch screen display or any other type of input device.

Computerized system 800 may be used to configure, operate, control, monitor, sense, and/or adjust devices, systems, and/or methods according to the present disclosure.

A communications subsystem 808 may be provided for one or both of transmitting and receiving signals over any form or medium of digital data communication, including a communication network. Examples of communication networks include a local area network (LAN), a wide area network (WAN), telecommunications network, cellular network, an inter-network such as the Internet, and peer-to-peer networks such as ad hoc peer-to-peer networks. Communications subsystem 808 may include any component or collection of components for enabling communications over one or more wired and wireless interfaces. These interfaces may include but are not limited to USB, Ethernet (e.g. IEEE 802.3), high-definition multimedia interface (HDMI), Firewire™ (e.g. IEEE 1374), Thunderbolt™, WiFi™ (e.g. IEEE 802.11), WiMAX (e.g. IEEE 802.16), Bluetooth™, or Near-field communications (NFC), as well as General Packet Radio Service (GPRS), Universal Mobile Telecommunications System (UMTS), Long-Term Evolution (LTE), LTE-A, 5G NR (New Radio), satellite communication protocols, and dedicated short range communication (DSRC). Communication subsystem 808 may include one or more ports or other components (not shown) for one or more wired connections. Additionally or alternatively, communication subsystem 808 may include one or more transmitters, receivers, and/or antenna. Further, computerized system 800 may comprise clients and servers (none of which are shown).

Computerized system 800 of FIG. 8 is merely an example and is not meant to be limiting. Various embodiments may utilize some or all of the components shown or described. Some embodiments may use other components not shown or described but known to persons skilled in the art.

Logical operations of the various embodiments according to the present disclosure may be implemented as (i) a sequence of computer implemented steps, procedures, or operations running on a programmable circuit in a computer, (ii) a sequence of computer implemented operations, procedures, or steps running on a specific-use programmable circuit; and/or (iii) interconnected machine modules or program engines within the programmable circuits. The computerized device or system 800 of FIG. 8 may practice all or part of the recited methods or operations, may be a part of systems according to the present disclosure, and/or may operate according to instructions in computer-readable storage media. Such logical operations may be implemented as modules configured to control a computer processor, such as processor 802, to perform particular functions according to the programming of the module. In other words, a computer processor, such as processor 802, may execute the instructions, steps, or operations according to the present disclosure, including of the one or more of the blocks or modules. For example, one or more of the modules or blocks in FIGS. 1-5 may be configured to control processor 802. For example, the modules or blocks in FIGS. 1-5 may include but are not limited to, for example, EV charging management system 110, 201, 301, optimizer 404, forecasters 414, 420, 426, 432, and so on. At least some of these blocks or modules may be stored on storage device 810 and loaded into memory 804 at runtime or may be stored in other computer-readable memory locations.

The concepts of real-time and near real-time may be defined as providing a response or output within a pre-determined time interval, usually a relatively short time. A time interval for real-time is generally shorter than an interval for near real-time. Mere non-limiting examples of predetermined time intervals may include the following as well as values below, between, and/or above these figures: 10 s, 60 s, 5 min, 10 min, 20 min, 30 min, 60 min, 2 hr, 4 hr, 6 hr, 8 hr, 10 hr, 12 hr, 1 day.

The term module used herein may refer to a software module, a hardware module, or a module comprising both software and hardware. Generally, software includes computer executable instructions, and possibly also data, and hardware refers to physical computer hardware.

Embodiments and operations according to the present disclosure may be implemented in digital electronic circuitry, and/or in computer software, firmware, and/or hardware, including structures according to this disclosure and their structural equivalents. Embodiments and operations according to the present disclosure may be implemented as one or more computer programs, for example one or more modules of computer program instructions, stored on or in computer storage media for execution by, or to control the operation of, one or more computer processing devices such as a processor. Operations according to the present disclosure may be implemented as operations performed by one or more processing devices on data stored on one or more computer-readable storage devices or media, and/or received from other sources.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not necessarily provided as to whether the embodiments described herein are implemented as a computer software, computer hardware, electronic hardware, or a combination thereof.

The term ‘data’ generally refers to raw or unorganized facts whereas ‘information’ generally refers to processed or organized data. However, the terms are generally used synonymously herein unless indicated otherwise.

In at least some embodiments, one or more aspects or components may be implemented by one or more special-purpose computing devices. The special-purpose computing devices may be any suitable type of computing device, including desktop computers, portable computers, handheld computing devices, networking devices, or any other computing device that comprises hardwired and/or program logic to implement operations and features according to the present disclosure.

Embodiments of the disclosure may be represented as a computer program product stored in a machine-readable medium (also referred to as a computer-readable medium, a processor-readable medium, or a computer usable medium having a computer-readable program code embodied therein). The machine-readable medium may be any suitable tangible, non-transitory medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations may also be stored on the machine-readable medium. The instructions stored on the machine-readable medium may be executed by a processor or other suitable processing device, and may interface with circuitry to perform the described tasks.

The structure, features, accessories, and/or alternatives of embodiments described and/or shown herein, including one or more aspects thereof, are intended to apply generally to all of the teachings of the present disclosure, including to all of the embodiments described and illustrated herein, insofar as they are compatible. Thus, the present disclosure includes embodiments having any combination or permutation of features of embodiments or aspects herein described.

In addition, the steps and the ordering of the steps of methods and data flows described and/or illustrated herein are not meant to be limiting. Methods and data flows comprising different steps, different number of steps, and/or different ordering of steps are also contemplated. Furthermore, although some steps are shown as being performed consecutively or concurrently, in other embodiments these steps may be performed concurrently or consecutively, respectively.

For simplicity and clarity of illustration, reference numerals may have been repeated among the figures to indicate corresponding or analogous elements. Numerous details have been set forth to provide an understanding of the embodiments described herein. The embodiments may be practiced without these details. In other instances, well-known methods, procedures, and components have not been described in detail to avoid obscuring the embodiments described.

The embodiments according to the present disclosure are intended to be examples only. Alterations, modifications and variations may be effected to the particular embodiments by those of skill in the art without departing from the scope, which is defined solely by the claims appended hereto.

The terms “a” or “an” are generally used to mean one or more than one. Furthermore, the term “or” is used in a non-exclusive manner, meaning that “A or B” includes “A but not B,” “B but not A,” and “both A and B” unless otherwise indicated. In addition, the terms “first,” “second,” and “third,” and so on, are used only as labels for descriptive purposes, and are not intended to impose numerical requirements or any specific ordering on their objects.

1. A system comprising:
a computer-readable storage medium having executable instructions; and
one or more hardware processors configured to execute the instructions to:
receive electric vehicle (EV) charging demand information;
receive energy cost information for an EV charging station, the energy cost information including current energy cost information and forecasted energy cost information, wherein actual energy costs vary over time;
execute an optimizer for maximizing predicted earnings on EV charging at the EV charging station based on the EV charging demand information and the energy cost information, wherein the maximizing comprises determining a dynamic optimized EV charging price; and
charge one or more EVs using the EV charging station at the dynamic optimized price.

2. The system of claim 1, wherein the maximizing further comprises determining a rate at which to charge a local energy storage system (ESS) using energy from a power grid, a rate at which to discharge energy from the ESS for charging the one or more EVs, or to neither charge nor discharge the ESS.

3. The system of claim 1, wherein the one or more hardware processors are configured to execute the instructions to:
generate forecasted on-site power generation information for one or more power generation sources of the EV charging station,
wherein the maximizing predicted earnings is also based on the forecasted on-site power generation information.

4. The system of claim 1, wherein the one or more hardware processors are configured to execute the instructions to:
transmit a signal to electronic devices of EV users indicative of the dynamic optimized EV charging price.

5. The system of claim 1, wherein the EV charging demand information includes current EV charging demand information and forecasted EV charging demand information.

6. The system of claim 1, wherein the optimizer maximizes predicted earnings over a time horizon window, wherein the EV charging demand information comprises forecasted EV charging demand information.

7. The system of claim 6, wherein the optimizer is configured for maximizing predicted earnings in the time horizon window by optimizing at least one of:
EV charging price at points in time in the time horizon window, and
a schedule in the time horizon window for charging a local energy storage system (ESS) using energy from a power grid, and for discharging energy from the ESS for charging the one or more EVs.

8. The system of claim 1, wherein the forecasted EV charging demand information is based at least in part on one or more of forecasted weather information and forecasted traffic information.

9. The system of claim 1, wherein the one or more hardware processors are configured to execute the instructions to:
receive EV charging demand information for each of a plurality of EV charging stations;
receive energy cost information for each of the plurality of EV charging stations;
execute the optimizer for maximizing predicted combined earnings on EV charging at the plurality of EV charging stations based on the EV charging demand information and the energy cost information, wherein the maximizing comprises determining a dynamic optimized EV charging price at each of the plurality of charging stations; and
charge one or more EVs using at least one of the EV charging stations at the respective dynamic optimized price for that EV charging station.

10. A method comprising:
at one or more electronic devices each having one or more hardware processors and computer-readable memory:
receiving electric vehicle (EV) charging demand information;
receiving energy cost information for an EV charging station, the energy cost information including current energy cost information and forecasted energy cost information, wherein actual energy costs vary over time;
executing an optimizer for maximizing predicted earnings on EV charging at the EV charging station based on the EV charging demand information and the energy cost information, wherein the maximizing comprises determining a dynamic optimized EV charging price; and
charging one or more EVs using the EV charging station at the dynamic optimized price.

11. The method of claim 10, wherein the maximizing further comprises determining a rate at which to charge a local energy storage system (ESS) using energy from a power grid, a rate at which to discharge energy from the ESS for charging the one or more EVs, or to neither charge nor discharge the ESS.

12. The method of claim 10, further comprising:
generating forecasted on-site power generation information for one or more power generation sources of the EV charging station,
wherein the maximizing predicted earnings is also based on the forecasted on-site power generation information.

13. The method of claim 10, further comprising:
transmitting a signal to electronic devices of EV users indicative of the dynamic optimized EV charging price.

14. The method of claim 10, wherein the EV charging demand information includes current EV charging demand information and forecasted EV charging demand information.

15. The method of claim 10, wherein the optimizer maximizes predicted earnings over a time horizon window, wherein the EV charging demand information comprises forecasted EV charging demand information.

16. The method of claim 15, wherein the optimizer is configured for maximizing predicted earnings in the time horizon window by optimizing at least one of:
EV charging price at points in time in the time horizon window, and
a schedule in the time horizon window for charging a local energy storage system (ESS) using energy from a power grid, and for discharging energy from the ESS for charging the one or more EVs.

17. The method of claim 10, wherein the forecasted EV charging demand information is based at least in part on one or more of forecasted weather information and forecasted traffic information.

18. The method of claim 10, comprising:
receiving EV charging demand information for each of a plurality of EV charging stations;
receiving energy cost information for each of the plurality of EV charging stations;
executing the optimizer for maximizing predicted combined earnings on EV charging at the plurality of EV charging stations based on the EV charging demand information and the energy cost information, wherein the maximizing comprises determining a dynamic optimized EV charging price at each of the plurality of charging stations; and
charging one or more EVs using at least one of the EV charging stations at the respective dynamic optimized price for that EV charging station.

19. A non-transitory computer-readable medium having computer-readable instructions stored thereon, the computer-readable instructions executable by at least one processor to cause the performance of operations comprising:
receiving electric vehicle (EV) charging demand information;
receiving energy cost information for an EV charging station, the energy cost information including current energy cost information and forecasted energy cost information, wherein actual energy costs vary over time;
executing an optimizer for maximizing predicted earnings on EV charging at the EV charging station based on the EV charging demand information and the energy cost information, wherein the maximizing comprises determining a dynamic optimized EV charging price; and
charging one or more EVs using the EV charging station at the dynamic optimized price.

20. The non-transitory computer-readable medium of claim 19, wherein the maximizing further comprises determining a rate at which to charge a local energy storage system (ESS) using energy from a power grid, a rate at which to discharge energy from the ESS for charging the one or more EVs, or to neither charge nor discharge the ESS.
